(19) United States
(12) Patent Application Publication
(10) Pub. No.: US 2009/0217272 A1
(43) Pub. Date: Aug. 27, 2009

(54) Method and Computer Program Product for Batch Processing

(76) Inventors: Vita Bortnikov, Haifa (IL); Shlomit Sarah Pinter, Haifa (IL); James Rush Rhyne, II, Los Gatos, CA (US)

Correspondence Address: IBM CORPORATION, T.J. WATSON RESEARCH CENTER, P.O. BOX 218, YORKTOWN HEIGHTS, NY, 10598, US

(21) Appl. No.: 12/037,099

(22) Filed: Feb. 26, 2008

(51) Int. Cl. G06F 9/46

(52) U.S. Cl. 718/101

(57) ABSTRACT

A method and computer program product for batch processing, the method includes: receiving a representation of a batch job that comprises a business logic portion and a non business logic portion; generating in real time business logic batch transactions in response to the representation of the batch job; and executing business logic batch transactions and online transactions; wherein the executing of business logic batch transactions is responsive to resource information and timing information.

### FIELD OF THE INVENTION

The present invention relates to methods and computer program products for batch processing.

### BACKGROUND OF THE INVENTION

Various computerized systems such as but not limited to mainframes can execute batch jobs and online transactions. A batch job is typically characterized by high volume and time dependent processing. It usually involves performing processing operations on a large set of input data (such as VSAM files) that must be available prior to execution. It does not need to be executed immediately like online transactions but it is characterized by timing limitations that can indicate when to start the batch job or when to end the batch job. A batch job also differs from online transactions by the following: (i) its input and output are only files, databases and queues instead of user interfaces or services like in online transaction processing; (ii) batch jobs are not interactive and information related to the execution of the batch job are logged in the job log file; and (iii) a batch job should be recoverable in case of failures.

Batch jobs are usually executed during batch windows. During a batch window, the online transactions are usually disabled. One of the major problems faced today by information technology (IT) organizations is the shrinking of the batch window.

Some prior art methods for executing batch jobs require that the batch job is written according to certain guidelines and that business logic code of the batch job is written in a certain programming language. If the business logic code is written in another programming language there is a need to re-write the business logic code. Re-writing the business logic code can be very costly and time consuming.

There is a growing need to provide efficient methods and computer program products for batch processing.

### SUMMARY

A method for batch processing, the method includes: receiving a representation of a batch job that comprises a business logic portion and a non business logic portion; generating in real time business logic batch transactions in response to the representation of the batch job; and executing business logic batch transactions and online transactions; wherein the executing of business logic batch transactions is responsive to resource information and timing information included in the non business logic portion.

### BRIEF DESCRIPTION OF THE DRAWINGS

The present invention will be understood and appreciated more fully from the following detailed description taken in conjunction with the drawings in which:

FIG. 1 illustrates a representation of a batch job according to an embodiment of the invention;

FIG. 2 illustrates a batch container and its environment according to an embodiment of the invention;

FIG. 3 illustrates a batch container according to an embodiment of the invention;

FIG. 4 illustrates a method for batch processing according to an embodiment of the invention;

FIG. 5 illustrates a method for generating a representation of a batch job according to an embodiment of the invention; and

FIG. 6 illustrates a system according to an embodiment of the invention.

### DETAILED DESCRIPTION OF THE DRAWINGS

A representation of a batch job is provided. It includes various batch job parameters like input, output, loop, end loop criterion and the like. The representation includes two separate portions—a business logic portion and another portion that is referred to as the non business logic portion. The non business logic portion includes resource information and timing information.

Business logic can be executed by executing entities. A block runner can include one or more execution entities. A block is a part of a batch job that was decided to be executed sequentially. An executing entity is adapted to execute business logic code and does not require a modification of the programming language of the business logic. Accordingly, legacy executing entities can be used for executing legacy business logic code.

Business logic can be regarded as the actual computation part of the batch job. It is also referred to as the main part of the batch job (its core).

Business logic code typically includes multiple repetitions of a loop. The business logic portion of the representation can include loop control information but this is not necessarily so. According to an embodiment of the invention, the business logic portion does not include loop control information.

The information included within the non business logic portion allows managing the execution of business logic transactions. These business logic transactions can be executed by a transaction processing systems that may include one or more batch containers. Conveniently, a transaction processing system can be modified by adding one or more batch containers. A transaction processing system can be a Customer Information Control System (CICS) transactional processing system of IBM of U.S.

Conveniently, at run time, a batch job is partitioned to multiple blocks, and each block is partitioned to multiple business logic transactions. An execution of a single business logic transaction can include executing a single iteration of a loop (or some designated number of iterations of the loop) and returning the result in some predefined way.

The partition of the representation to business logic portion and non business logic portion enables various portions of the batch container to perform operations (such as but not limited to transaction, checkpoints, logging, data copy, commit, etc.) without understanding the business logic code.

The batch container can perform locking and transaction commit/cancel.

Conveniently, resource information can have a similar format to the format specified by the Job Control Language (JCL) or extended JCL thus enabling simple translation from batch jobs that are written according to the JCL format.

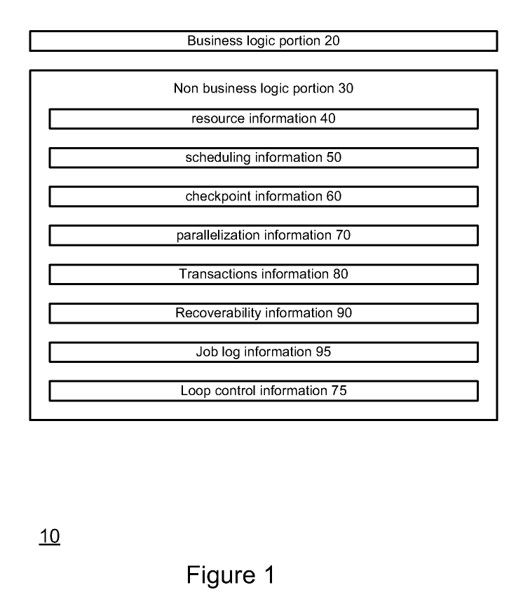

FIG. 1 illustrates representation 10 of a batch job according to an embodiment of the invention.

Representation 10 includes business logic portion 20 and non business logic portion 30. Non business logic portion 30 includes resource information 40, scheduling information 50, checkpoint information 60, parallelization information 70, transaction information 80, loop control information 75 recoverability information 90, and job log information 95.

Resource information 40 can describe resources such as files, databases, queues or memory resources. The resources are the inputs and outputs of the batch job.

Scheduling information 50 can include scheduling parameters that define the time dependency of the batch job. The scheduling information 50 can include a batch job starting time and batch job deadline.

Checkpoint information 60 can define checkpoints. Checkpoints provide failure recovery of the data processed by the batch job.

Parallelization information 70 can include parallelization directives in order to facilitate the parallel execution of batch job blocks. It can include parallelization factor approximation.

A typical batch job processes input data (file or database) and creates output data. The processing can include merging, filtering, summarizing, or data transformation. A batch job usually includes multiple steps. Each step could have its own input and output resources. In many cases, the output of one step is the input to another step. Resource information 40 describes resources that are to be used by the batch job. It is expected that resource information can assist in the management of business logic transactions and especially in their scheduling. Resource information 40 can also be of use when determining how to parallelize the execution of batch job blocks.

Typical resource parameters include at least one of the following: (i) Name—the name of the resource; (ii) Path—a fully qualified path that serves for unique resource identification (file full name, database identifier and the like); (iii) Type—type of the resource, including but not limited to: database, file (VSAM or other), queue, memory (temporary storage) and the like; (iv) Access—the access done to the resource by the whole batch job. Possible values can include read only, write only or read and write; (v) Role—description of the role of that resource. (vi) Record size—the size of the record (for record based resources). This field could be used for key determination, filtering etc. (vii) Sorted—describes whether the resource identifier is sorted or not and the sorting key. The sorting key could be described as an offset in the record. The sorting key can include a comparison function.

Resource information 40 can also describe resources that are used by each step (this information is referred to as step resource information). Step resource information includes at least one of the following: (i) name—the name of the resource (should be identical to its name in the job description); (ii) access—the access that is done to the resource by the step, this may be different from the access by the whole job, since some steps could only read or only write to the resource, this access information can specify access methods for the input files, indicate if an input file is read only, shared by several steps/jobs, or modified by the step; specify access methods for the output file, indicate if an output file is written by a single step or shared (for write) by several steps/jobs; and (iii) usage pattern—the usage pattern that the step performs with the resource. This should help in better job scheduling/parallelization. Possible values are: sequential, random, unknown.

It is noted that step resource information can specify I/O dependencies. These I/O dependencies can indicate, for example, if a step is waiting for an existing file that should be first updated by another step.

Step resource information can also indicate a size of a record in the input file or some estimation on the number of records in the file.

Scheduling information 50 can include various scheduling parameters of the batch job such as but not limited to at least one of the following or a combination thereof: (i) Start time—the earliest time the batch job can be started. Usually the start time is determined by the input data availability. (ii) Deadline time—the time when the batch job should be completed and its results be available. (ii) Repeating—the batch job could be run repeatedly on a daily, weekly or monthly basis. (iii) Priority information that can influence job scheduling.

Parallelization information 70 can include a parallelization factor—the factor provides a recommendation for parallelization that is good for the step and an iterations independent parameter that specifies whether iterations of a step are independent.

Transactions information 80 can indicate or assist in the conversion of a single batch job (that can be very long) to blocks that include multiple business logic transactions that are transaction processing system compliant transactions (for example—CICS transactions). Transactions information can indicate how many loop iterations (one or more) should be included in a single business logic transaction. It is noted that this information can be regarded as a recommendation and that the batch container can ignore this recommendation.

Recoverability information 90 can indicate what to do in case that some of the steps of the batch job fail. For example—the batch job can wait for the steps to recover, the batch job can fail and role back successful steps.

Job log information 95 can describe the name (or other characteristics) of a batch job log file.

Business Logic portion 10 can describe the business logic. A batch job could include one or more steps. A step usually includes a loop that process input data and creates an output data.

Loop control information can be included in the business logic (implicit manner) or not included in the business logic (explicit manner). For simplicity of explanation FIG. 1 illustrates loop control information 75 as included in non business logic portion 30. Control loop information can indicate the type of the loop.

The explicit manner includes describing the loop as part of the step and the business logic describes a single iteration of the loop. Thus, loop control information is not included in the business logic (as illustrated in FIG. 1). Loop control can include checking whether the loop should end—for example it can include a “while” condition, a “until” condition, and the like. In this case, the end of the loop is evaluated by the batch container.

In the implicit loop case, the business logic includes the loop control information. The batch container is not aware of the loop control information.

The explicit way has various advantages: (i) the batch container has control over the iterations of the loop that enables better scheduling and simple parallelization; (ii) transaction control and checkpoints could be executed without changes to the business logic; and (iii) the single iteration business logic is similar to a single online transaction. Specifying batch job steps using explicit loop provide a good way of code reuse.

Business logic that is associated with a step can be described by loop specification information, name of step, resources of the step; return value of the step; dependency information; execution estimation information.

Loop control information can include loop behavior information that describes the behavior of an (explicit) loop. Possible values are: (i) “For each input element”—the business logic is executed for each element in the input data set in the sequential order. (Equivalent to “while not EOF do.”); (ii) “N iterations”—execute the business logic N times (implicit loop is one iteration); (iii) “While (condition) do”—loop while the condition is true. The condition will usually be a result of the business logic execution. The so called “body” of the loop is fully contained in a single business logic transaction.

Step related information can include return value information that describes the return value of the business logic step. This value could be used for conditional executions of steps or loops.

Step related information can include dependency information that describes whether a step depends upon one or more other steps. This does not necessarily include resources dependencies that could be computed. The information can assist in the parallelization.

Step related information can include execution estimation that can provide an estimate of the time the execution of a single iteration takes.

Conveniently, representation 10 can include steps that are selected from a list of pre-defined steps. These pre-defined steps can simplify the parallelism. These pre-defined steps can include at least one of the following: (i) Sort—sort the input data. The step receives an input file, sorts it, and writes the sorted data to the output file; (ii) Split k—split the input data. This step receives the input file and splits it to k parts. (iii) Merge—merges k data sets to a single data set—usually used after running some algorithm on parts of input. (iv) Sorted Merge—merges k sorted data sets to a single sorted data set.

These pre-defined steps can be library functions that could be very useful not only for parallelization purposes.

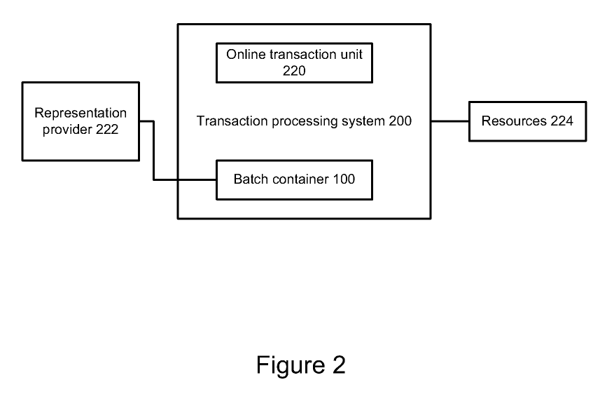

FIG. 2 illustrates batch container 100 and its environment according to an embodiment of the invention.

Transaction processing system 200 includes batch container 100, online transaction unit 220 and representation provider 222. Transaction processing system 200 can execute business logic transactions as well as online transactions. Online transaction unit 220 can execute online transactions while batch container 100 executes business logic transactions. Both transactions can access at least one shared resource of resources 224. Representation provider 222 sends batch container 100 representations of batch jobs such as representation 10 of FIG. 1. Representation provider 222 can be a user computer, a server and the like.

Batch container 100 can be a CICS batch container that provides a framework for executing batch jobs in a CICS environment. Batch container 100 can receive as input a representation such as representation 10 of FIG. 1.

Batch container 100 can provide a framework for batch job analysis and parallelization. The batch container enables time dependent job scheduling. Batch container 100 can also provide monitoring and control of the submitted batch jobs.

Batch container 100 is an environment for hosting batch jobs. A batch job can be deployed (submitted), scheduled and run by batch container 100. Batch container 100 manages every aspect of the batch job, while a block runner executes a single block at a time including its business logic.

The services provided to a hosted batch job by batch container 100 include at least one of the following: (i) transactions—data isolation, check-pointing, and failure recovery. A batch job has parameters that indicate its requirement for locking and check-pointing. Those parameters are addressed by the batch container; (ii) Resources—the resources (files, databases, queues etc.) are managed by batch container 100. (iii) Logging—batch container 100 will provide events logging facility and job status notifications. It can save, manage, and provide users with batch job logs; (iv) Batch job life cycles management—batch container 100 performs life cycle management for the batch job. It starts/stops/suspends/resume the hosted batch job; and (v) Job data persistency—batch container 100 provides the batch job with a service to save and fetch persistent data.

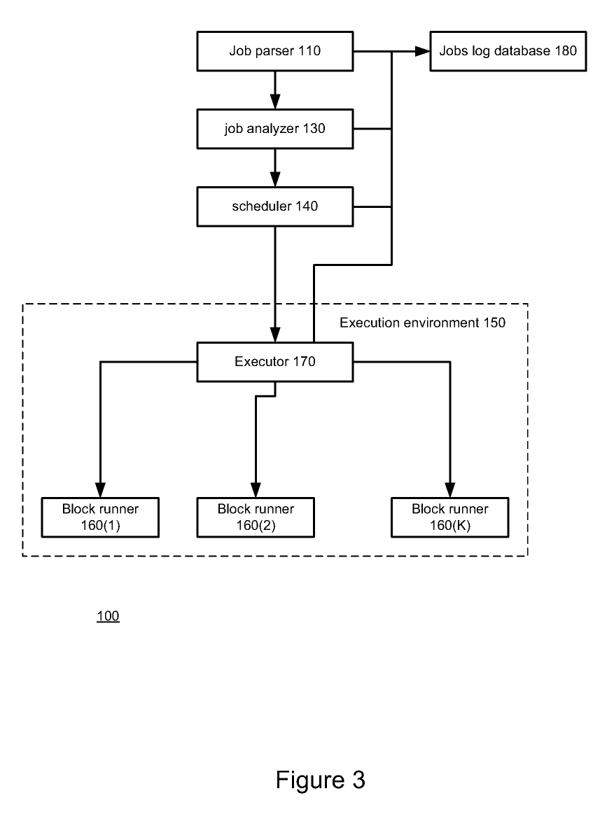

FIG. 3 illustrates batch container 100 according to an embodiment of the invention.

Batch container 100 includes job parser 110, job analyzer 130, scheduler 140, executor 170 and multiple block runners 160(1)-160(K).

Executor 170 and block runners 160(1)-160(K) form execution environment 150. Batch jobs are scheduled by scheduler 140 and then dispatched (in the order defined by the scheduler) to execution environment 150. Execution environment 150 is responsible to execute the batch job and return to scheduler 140 with a status notification.

Parser 110 parses the representation of the batch job (such as representation 10) from a representation format (for example—an XML format) to a batch container format. Analyzer 130 analyses batch jobs and steps, takes parallelization decisions, and divides each batch job into blocks. Scheduler 140 schedules blocks based on the dependencies, job start time and deadlines. Executor 170 receives blocks for execution (sorted) and sends them, one by one, to block runners 160(1)-160(K). Executor 170 is responsible for keeping block runners busy. Executor 170 gets responses and puts them in jobs log database 180. Block runners 160(1)-160(K) are execution entities that execute blocks. Each block runner can execute a block at a time. A block can contain one or more iteration of a loop and the results of its execution returned a result to the batch container 100. The number of loop iteration is defined by the transaction parameters.

Most batch jobs have completion deadline and require that their input data (e.g., VSAM files) will be ready before they start executing. Scheduler 140 can provide advanced programming interfaces (APIs) to a representation provider 222 for submitting the job representation. Conveniently, submitted batch job representations, their states, logs files and the like are stored in jobs log database 180. These APIs can include, for example, at least one of the following: (i) submit job—submits the batch job, and returns its identifier; (ii) cancel job—cancel the batch job (by identifier); (iii) restart Job—restart the batch job; which is relevant to the job in the restartable state; (iv) suspend job—suspend the executing job; (v) resume job; (vi) remove job—removes the completed batch job form the system; (vii) show status—return the status of the batch job; (viii) show log—show the log of the batch job; (ix) list all running jobs—get the identifiers of all currently executing batch jobs; (x) list all jobs—get all batch jobs in the system, their identifiers and state; (xi) get job details—get the details of the batch job, including extended JCL and state.

After getting a new batch job, scheduler 140 schedules the new batch job in response to the batch job parameters (like start time, deadline, priority etc.) and to transaction processing system 200 parameters (e.g., how many batch jobs could be scheduled concurrently). Conveniently, scheduler 140 should submit only batch jobs that are ready for execution. Scheduler 140 can provide an interface to start, stop, and suspended batch jobs.

Conveniently, scheduler 140 can receive indications of the progress of batch jobs and respond to it. Scheduler 140 can change the scheduling plan.

It is noted that transaction processing system 200 can receive scheduling information from an external scheduler (not shown). An external scheduler can submit batch jobs scheduling information to scheduler 140. An external scheduler can get the result of the submitted batch job as well as subscribe and listen to the batch job progress.

Execution Environment 150 can execute batch jobs. It can split a batch job into business logic transactions, prepare input, perform checkpoints, and write a job log. Execution environment 150 updates job database 180 with the batch job data.

Execution environment 150 is responsible for preparing each business logic transaction with its input data, and for locking the resources when needed. In addition, before running a batch job, the dependencies between business unit transactions are calculated and this information is used for business unit transactions parallelization.

Batch container 100 performs batch job analysis, divides each batch job into blocks, and orders the blocks based on dependencies between blocks. A block can be longer than one business unit transaction thus—commits can be executed inside a block.

Conveniently, batch container 100 is CICS compliant batch container. A CICS batch container provides a framework for executing batch jobs in CICS. JCICS APIs are used to perform CICS related operations. Accordingly, a batch job is divided into smaller CICS business logic transactions. Those transactions run by the batch container using JCICS APIs. The CICS business logic transactions derived from the batch job can be executed with lower priority than online transactions.

The business logic can be a stand alone CICS program that is invoked by the CICS batch container through a CICS LINK command. According to another embodiment of the invention, a part of the batch container is a native CICS program (container agent).

Conveniently, a batch job is converted to multiple blocks and at least two of these blocks are executed in parallel—they can be provided to different block runners and be executed in parallel to each other.

For example—assuming that a batch job includes a single step that is wrapped in a loop. This step reads a record from an input file, does some computation, accumulate a value in a variable (for example variable total_sum), and then loops back to read the next record. Once all the records were read the job prints total_sum and finishes.

If the number of records in the input file is large, such a step, when running out of the batch window, can be a burden on transaction workload. On the other hand, it will not be wise to split the step so that the processing of each record will constitute a transaction. It is assumed that integer n is the number of input records (or some estimation of that number), and n/k, for some integer k is the number of records in an input file for which processing is fast enough to be run as a single business logic transaction.

The job will be split to the following blocks: Block₀: divide the input file into k parts: in₁, . . . , inₖ, initialize each step and fork; Block₁, . . . , Blockₖ: each step runs the loop body on input parts in₁, . . . , inₖ respectively; Blockₖ₊₁: add the result values of the total_sum variable from each Block₁, . . . , Blockₖ and print result.

The batch job split has several advantages: all its short running blocks can co-exists with short lived online transactions, it can better sustains failures—e.g., if a single block fails only its input need to be summarized again during the recovery. The split of the batch job to steps enables blocks parallelism and then the new batch job can also finish faster when there are enough free resources (due to the parallelism).

It noted that not all blocks can be executed in parallel. This can occur, for example, if one block needs an output of another block. In order to determine whether parallelism is possible and if so—how to parallelize the execution of blocks, batch container 100 analyzes the step's input and output access and uses the dependency information of the representation.

Yet for another example, and assuming that the batch job sorts data. If the input file has about million records to sort, it can not co-exist with online transactions. Let n be the number of input records (or some estimation of that number), and n/k, for some integer k, be the number of records in an input file for which sorting is fast enough to be run as a simple business logic transaction. Our restructured parallelized batch job will have the following steps: Block₀: divide the input file into k parts: in₁, . . . , inₖ, initialize each step and fork; Block₁, . . . , Blocktₖ: each step is a sort on input file in₁, . . . inₖ respectively; Blockₖ₊₁: merge output results of Block₁, . . . , Blockₖ.

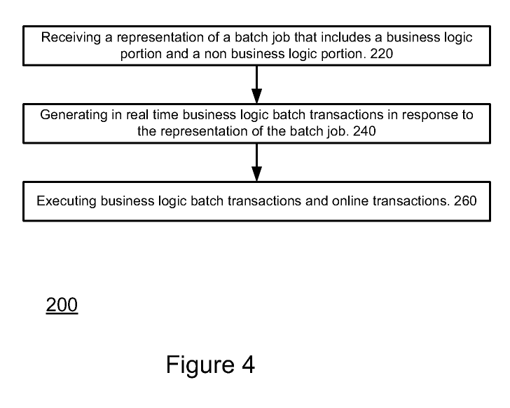

FIG. 4 illustrates method 200 for batch processing, according to an embodiment of the invention.

Method 200 starts by stage 220 of receiving a representation of a batch job that includes a business logic portion and a non business logic portion. Stage 220 can include receiving a representation such as representation 10 of FIG. 1.

Stage 220 is followed by stage 240 of generating in real time business logic batch transactions in response to the representation of the batch job. Stage 220 can be executed by batch container 100 of FIGS. 2 and 3.

Stage 240 is followed by stage 260 of executing business logic batch transactions and online transactions. The executing of business logic batch transactions is responsive to resource information and timing information included in the non business logic portion.

Stages 240 and 260 can be executed by transaction processing system 200 of FIG. 2. The resource information and timing information can be utilized by batch container 100 to control and schedule the execution of business logic transactions.

Conveniently, stage 260 can include providing at least one service out of: data isolation, check-pointing, failure recovery, resource access management, event logging, batch job life cycle management and batch job data persistency.

Conveniently, stage 240 can include partitioning the business logic portion to blocks. A block includes multiple business logic batch transactions that are executed in a sequential manner.

According to an embodiment of the invention stage 240 can include executing multiple blocks in parallel.

Stage 220 can include receiving a business logic portion that does not include loop control information. This is not necessarily so and the business logic portion can include loop control information.

Stage 240 can be executed without converting a programming language of business logic code.

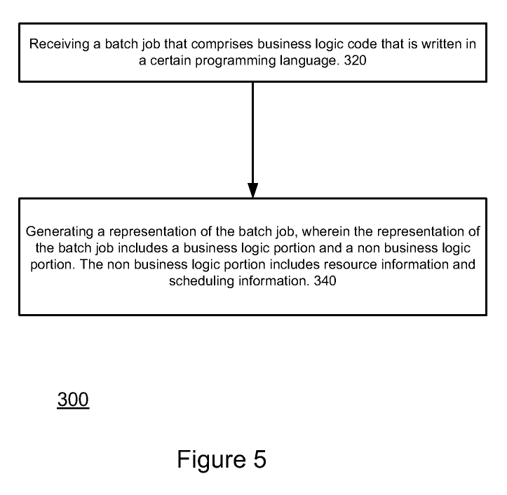

FIG. 5 illustrates method 300 for generating a representation of a batch job according to an embodiment of the invention.

Method 300 starts by stage 320 of receiving a batch job that comprises business logic code that is written in a certain programming language.

Stage 320 is followed by stage 340 of generating a representation of the batch job, wherein the representation of the batch job includes a business logic portion and a non business logic portion. The non business logic portion includes resource information and scheduling information.

Stage 340 of generating does not change the programming language of the business logic code.

Stage 340 can include analyzing the batch job. The analysis can derive most of the representation parameters like input, output, loop, end loop, and iteration dependencies.

Tools for code analysis like WSAA, ATW and Mystery will be used to analyze code written in COBOL and JCL, and find dependencies between different steps and iterations.

Conveniently, stage 340 also includes generating checkpoint information and parallelization information.

Conveniently, the outcome of method 300 is a representation such as representation 10 of FIG. 1.

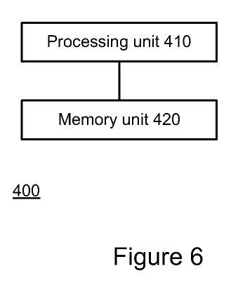

FIG. 6 illustrates system 400 according to an embodiment of the invention. System 400 can execute method 200 and additionally or alternatively can execute method 300. System 400 can include processing unit 410 and memory unit 420.

According to an embodiment of the invention memory unit 420 can store a batch job that includes business logic code that is written in a certain programming language. Processing unit 410 can generate a representation of the batch job, wherein the representation of the batch job comprises a business logic portion and a non business logic portion that comprises resource information and scheduling information; wherein the generating does not change the programming language of the business logic code.

According to another embodiment of the invention memory unit 420 stores a representation of a batch job that comprises a business logic portion and a non business logic portion. Processing unit 410 generates in real time business logic batch transactions in response to the representation of the batch job; and executes business logic batch transactions and online transactions; wherein the executing of business logic batch transactions is responsive to resource information and timing information included in the non business logic portion.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can store information that can be read by electronic, magnetic, optical, electromagnetic or infrared based techniques, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for batch processing, the method comprises: receiving a representation of a batch job that comprises a business logic portion and a non business logic portion; generating in real time business logic batch transactions in response to the representation of the batch job; and executing business logic batch transactions and online transactions; wherein the executing of business logic batch transactions is responsive to resource information and timing information included in the non business logic portion.

2. The method according to claim 1 comprising managing an execution of the business logic batch transaction by a batch container; wherein the managing is responsive to the resource information and to the timing information.

3. The method according to claim 2 wherein the managing comprises providing at least one service out of a list consisting of data isolation, check-pointing, failure recovery, resource access management, event logging, batch job life cycle management and batch job data persistency.

4. The method according to claim 1 comprising partitioning the business logic portion to blocks; wherein a block comprises multiple business logic batch transactions that are executed in a sequential manner.

5. The method according to claim 4 comprising executing multiple blocks in parallel.

6. The method according to claim 4 further comprising partitioning a block to multiple business logic batch transactions.

7. The method according to claim 1 wherein only the non business logic portion comprises loop control information.

8. The method according to claim 1 comprising generating the representation of the batch job in response to a batch job without converting a programming language of business logic code.

9. A method for generating a representation of a batch job, the method comprises: receiving a batch job that comprises business logic code that is written in a certain programming language; and generating a representation of the batch job, wherein the representation of the batch job comprises a business logic portion and a non business logic portion that comprises resource information and scheduling information; wherein the generating does not change a programming language of the business logic code.

10. The method according to claim 9 comprising generating checkpoint information and parallelization information.

11. A computer program product comprising a computer usable medium including a computer readable program, wherein the computer readable program when executed on a computer causes the computer to: receive a representation of a batch job that comprises a business logic portion and a non business logic portion; generate in real time business logic batch transactions in response to the representation of the batch job; and execute business logic batch transactions and online transactions; wherein the execution of business logic batch transactions is responsive to resource information and timing information included in the non business logic portion.

12. The computer program product according to claim 11 that causes the computer to manage an execution of the business logic batch transaction by a batch container; wherein the managing is responsive to the resource information and to the timing information.

13. The computer program product according to claim 12 that causes the computer to providing at least one service out of a list consisting of data isolation, check-pointing, failure recovery, resource access management, event logging, batch job life cycle management and batch job data persistency.

14. The computer program product according to claim 11 that causes the computer to partition the business logic portion to blocks; wherein a block comprises multiple business logic batch transactions that are executed in a sequential manner.

15. The computer program product according to claim 14 that causes the computer to execute multiple blocks in parallel.

16. The computer program product according to claim 14 that causes the computer to partition a block to multiple business logic batch transactions.

17. The computer program product according to claim 14 wherein the business logic portion does not comprise loop control information.

18. The computer program product according to claim 11 that causes the computer to generate the representation of the batch job in response to a batch job without converting a programming language of business logic code.

19. A computer program product comprising a computer usable medium including a computer readable program, wherein the computer readable program when executed on a computer causes the computer to: receive a batch job that comprises business logic code that is written in a certain programming language; and generate a representation of the batch job, wherein the representation of the batch job comprises a business logic portion and a non business logic portion that comprises resource information and scheduling information; wherein the generation does not change a programming language of the business logic code.

20. The computer program product according to claim 19 that causes the computer to generate checkpoint information and parallelization information.
